(19) United States
(12) Patent Application Publication
(10) Pub. No.: US 2014/0067555 A1
(43) Pub. Date: Mar. 6, 2014

(54) METHOD AND SYSTEM FOR PROVIDING ONLINE ADVERTISEMENTS BASED ON USER DRIVEN DEVICE MOTION INPUTS

(71) Applicants: Deepak PAKHARE, Mumbai (IN); Neeraj BAGDIA, Bangalore (IN); Anshuman KUMAR, Lucknow (IN); Sarit ARORA, Bangalore (IN); Ashutosh KUMAR, Bangalore (IN); Uday M. SHANKAR, Bangalore (IN)

(72) Inventors: Deepak PAKHARE, Mumbai (IN); Neeraj BAGDIA, Bangalore (IN); Anshuman KUMAR, Lucknow (IN); Sarit ARORA, Bangalore (IN); Ashutosh KUMAR, Bangalore (IN); Uday M. SHANKAR, Bangalore (IN)

(73) Assignee: Yahoo! Inc., Sunnyvale, CA (US)

(21) Appl. No.: 13/597,272

(22) Filed: Aug. 29, 2012

(51) Int. Cl. G06Q 30/02

(52) U.S. Cl. 705/14.73

(57) ABSTRACT

A method and system for providing online advertisements based on user driven device motion inputs. The method includes receiving one or more device motion inputs for a static advertisement from a user of an electronic device. The method also includes fetching data based on the one or more device motion inputs. The data includes at least one of acceleration data and multi-directional data. The method further includes correlating the data to one or more objects associated with the static advertisement. Further, the method includes creating an interactive advertisement based on correlation of the data to the one or more objects. Moreover, the method includes displaying the interactive advertisement to the user. The system includes an electronic device, communication interface, memory, and processor.

### TECHNICAL FIELD

Embodiments of the disclosure relate to the field of providing online advertisements based on user driven device motion inputs.

### BACKGROUND

Currently, advertisers constantly deal with limited choices when it comes to online advertising. In one example, ad formats are static boxes and rectangles that curb creativity and limit potential to create engaging and immersive ad experiences for users. Existing hand held devices have an opportunity for better ad experiences. However, the ad experiences are limited to extension of the online advertising. End users are hence faced with poor ad experiences and highly intrusive advertising. Such advertising diverts attention of a user as well as loses opportunity to engage the user for brand messaging and conversions, thereby leading to decrease in profits.

In light of the foregoing discussion, there is a need for a method and system for an efficient technique to provide online advertisements based on user driven device motion inputs on hand held devices.

### SUMMARY

The above-mentioned needs are met by a method, a computer program product and a system for providing online advertisements based on user driven device motion inputs.

An example of a method of providing online advertisements based on user driven device motion inputs includes receiving one or more device motion inputs for a static advertisement from a user of an electronic device. The method also includes fetching data based on the one or more device motion inputs. The data includes at least one of acceleration data and multi-directional data. The method further includes correlating the data to one or more objects associated with the static advertisement. Further, the method includes creating an interactive advertisement based on correlation of the data to the one or more objects. Moreover, the method includes displaying the interactive advertisement to the user.

An example of a computer program product stored on a non-transitory computer-readable medium that when executed by a processor, performs a method of providing online advertisements based on user driven device motion inputs includes receiving one or more device motion inputs for a static advertisement from a user of an electronic device. The computer program product also includes fetching data based on the one or more device motion inputs. The data includes at least one of acceleration data and multi-directional data. The computer program product further includes correlating the data to one or more objects associated with the static advertisement. Further, the computer program product includes creating an interactive advertisement based on correlation of the data to the one or more objects. Moreover, the computer program product includes displaying the interactive advertisement to the user.

An example of a system for providing online advertisements based on user driven device motion inputs includes an electronic device. The system also includes a communication interface in electronic communication with the electronic device. The system further includes a memory that stores instructions, and a processor. The processor is responsive to the instructions to receive one or more device motion inputs for a static advertisement from a user of an electronic device. The processor is also responsive to the instructions to fetch data based on the one or more device motion inputs. The data includes at least one of acceleration data and multi-directional data. The processor is further responsive to the instructions to correlate the data to one or more objects associated with the static advertisement, to create an interactive advertisement based on correlation of the data to the one or more objects, and to display the interactive advertisement to the user.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment;

and

FIG. 3 is a flowchart illustrating a method of providing online advertisements based on user driven device motion inputs, in accordance with one embodiment.

### DETAILED DESCRIPTION OF THE EMBODIMENTS

The above-mentioned needs are met by a method, computer program product and system for providing online advertisements based on user driven device motion inputs. The following detailed description is intended to provide example implementations to one of ordinary skill in the art, and is not intended to limit the invention to the explicit disclosure, as one or ordinary skill in the art will understand that variations can be substituted that are within the scope of the invention as described.

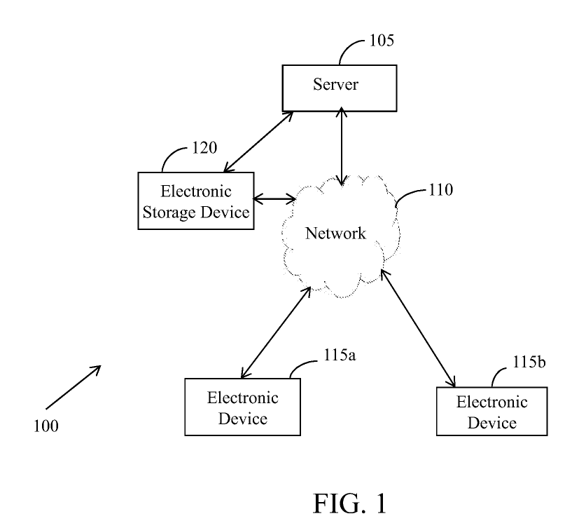

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, tablets, laptops, palmtops, hand held devices, telecommunication devices, and personal digital assistants (PDAs).

The electronic devices can communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example one or more device motion inputs, data, a static advertisement, and an interactive advertisement.

In some embodiments, different electronic storage devices are used for storing the information.

The server 105, for example a Yahoo!® server, receives one or more device motion inputs for a static advertisement from a user of the electronic device 105A. The server 105 fetches data based on the device motion inputs. The data includes at least one of acceleration data and multi-directional data. The server 105 also correlates the data to one or more objects associated with the static advertisement. The server 105 further creates an interactive advertisement based on correlation of the data to the objects. The server 105 further displays the interactive advertisement to the user.

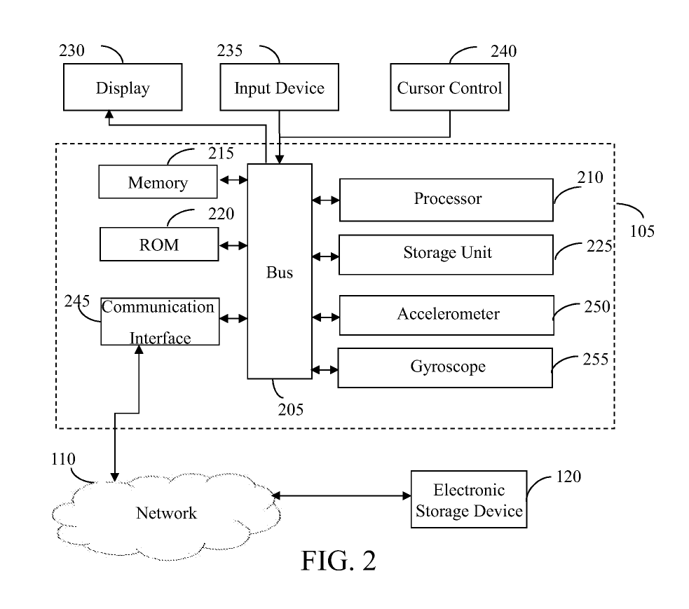

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example one or more device motion inputs, data, a static advertisement, and an interactive advertisement.

The server 105 can be coupled via the bus 205 to a display 230, for example a cathode ray tube (CRT), and liquid crystal display (LCD) for displaying interactive advertisements. An input device 235, including alphanumeric and other keys, is coupled to the bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the one or more device motion inputs, the data, the static advertisement, and the interactive advertisement.

The server 105 further includes an accelerometer 250 and a gyroscope 255. The accelerometer 250 renders acceleration data and the gyroscope 255 renders multi-directional data.

The processor 210 in the server 105, for example a Yahoo!® server, receives one or more device motion inputs for a static advertisement from a user of the electronic device 105A. The processor 210 fetches data based on the device motion inputs. The data includes at least one of acceleration data and multi-directional data. The processor 210 also correlates the data to one or more objects associated with the static advertisement. The processor 210 further creates an interactive advertisement based on correlation of the data to the objects. The processor 210 further displays the interactive advertisement to the user.

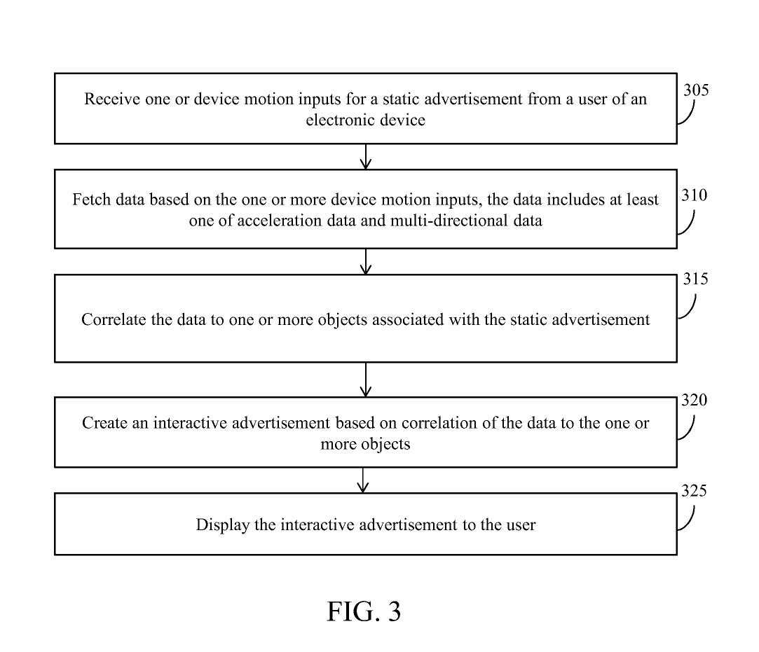

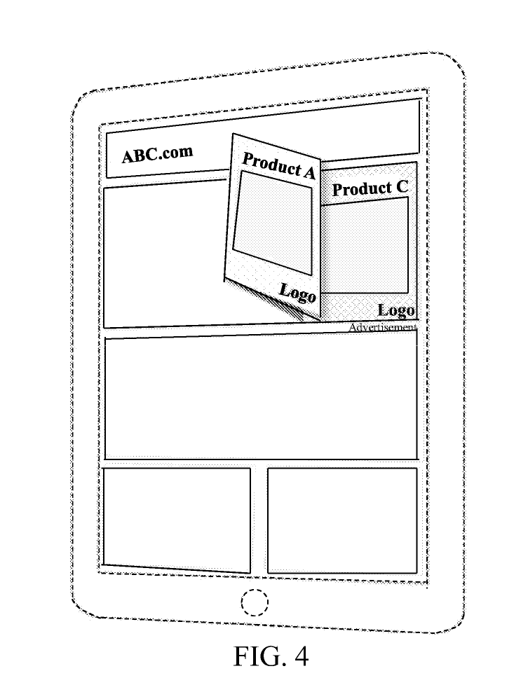

FIG. 3 is a flowchart illustrating a method of providing online advertisements based on user driven device motion inputs, in accordance with one embodiment.

At step 305, one or more device motion inputs are received for a static advertisement from a user of an electronic device. The static advertisement is displayed on one of an online website and an inbuilt application on the electronic device. Examples of the device motion inputs include, but are not limited to, touch input, tilt input, rotatory input, shake input, pan input, and a vibration input.

At step 310, data is fetched based on the one or more device motion inputs. The data includes at least one of acceleration data and multi-directional data. The acceleration data is fetched from an accelerometer in a server, for example the accelerometer 250 in the server 105. Similarly, the multi-directional data is fetched from a gyroscope in a server, for example the gyroscope 255 in the server 105. The acceleration data and the multi-directional data thus fetched correspond to the device motion inputs of the user.

At step 315, the data is correlated to one or more objects associated with the static advertisement. The acceleration data and the multi-directional data is correlated to associated objects in the static advertisement.

In one example, a Safari browser in iOS4 is capable of reading the acceleration data and the multi-directional data.

At step 320, an interactive advertisement is created based on correlation of the data to the objects. The static advertisement gets converted to the interactive advertisement after correlation of the data to the objects.

In some embodiments, the the interactive advertisement is activated based on user control of the electronic device.

At step 325, the interactive advertisement is displayed to the user. The interactive advertisement is displayed to the user based on different device motion inputs provided by the user.

In some embodiments, the device motion inputs, the data, the static advertisement, and the interactive advertisement can be stored in an electronic storage device, for example the electronic storage device 120.

In other embodiments, the device motion inputs, the data, the static advertisement, and the interactive advertisement can be stored in a storage unit, for example the storage unit 225, in a server, for example the server 105. In one example, the server can be a centralized server or a distributed server of Yahoo!®.

In some embodiments, the interactive advertisement can be customized by the user.

In some embodiments, the acceleration data and the multi-directional data is fetched from the electronic device when the interactive advertisement is served for the inbuilt application. In other embodiments, the acceleration data and the multi-directional data is fetched based on a call made to a browser when the interactive advertisement is served for the online website. The data is further translated into desired experience as defined by an ad-format or as conceptualized by an advertiser or agency in form of an ad creative.

In one example, a brand advertiser, for example a cold drink manufacturer, wants to custom-create and launch a campaign to engage users on an inbuilt application. A user accesses the inbuilt application on an electronic device, for example a tablet, and reads a magazine. The user views an advertisement of the cold drink manufacturer on right hand side of screen of the tablet. The ad creative illustrates an empty glass and a cold drink bottle. As the user tilts the tablet, cold drink spills from wobbling cold drink bottle onto webpage. The user can tap the advertisement which then occupies the screen of the tablet. The advertisement suggests to the user to pour the cold drink in the empty glass by tilting the tablet. The tilt input provided by the user is the device motion input in this case.

In another example, as illustrated in FIG. 4, an apparel manufacturer wants to promote a latest fashion line for businesswomen and decide to target women on smart phones and tablets on an online website, for example ABC.com, with an engaging ad experience. The online website pitches a catalogue ad-format to the women. The catalogue ad-format leverages an accelerometer based framework. When the user sees an advertisement of the apparel manufacturer on the online website on a tablet, the ad creative appears like a folded catalogue. On tilting the tablet, the catalogue unfolds progressively to reveal multiple folds each containing specific product information, for example one fold including logo of the apparel manufacturer and product information of product A and another fold including the logo and product information of product C. The tilt input provided by the user is the device motion input in this case also.

The present disclosure provides online advertisements based on user driven device motion inputs to enhance user interest and advertisement experience. The present disclosure also enables advertisers to craft more compelling brand experiences for which premium rates can be charged. Hence, the method and system in the present disclosure enables Yahoo! to provide interactive online and inbuilt application advertising experiences for users.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing online advertisements based on user driven device motion inputs, the method comprising:
receiving one or more device motion inputs for a static advertisement from a user of an electronic device;
fetching data based on the one or more device motion inputs, wherein the data comprises at least one of acceleration data and multi-directional data;
correlating the data to one or more objects associated with the static advertisement;
creating an interactive advertisement based on correlation of the data to the one or more objects; and
displaying the interactive advertisement to the user.

2. The method as claimed in claim 1 and further comprising displaying the static advertisement on one of an online website and an inbuilt application.

3. The method as claimed in claim 1, wherein the acceleration data is rendered by an accelerometer.

4. The method as claimed in claim 1, wherein the multi-directional data is rendered by a gyroscope.

5. The method as claimed in claim 1 and further comprising activating the interactive advertisement based on user control of the electronic device.

6. The method as claimed in claim 1 and further comprising customizing the interactive advertisement by the user.

7. A computer program product stored on a non-transitory computer-readable medium that when executed by a processor, performs a method of providing online advertisements based on user driven device motion inputs, comprising:
receiving one or more device motion inputs for a static advertisement from a user of an electronic device;
fetching data based on the one or more device motion inputs, wherein the data comprises at least one of acceleration data and multi-directional data;
correlating the data to one or more objects associated with the static advertisement;
creating an interactive advertisement based on correlation of the data to the one or more objects; and
displaying the interactive advertisement to the user.

8. The computer program product as claimed in claim 7 and further comprising
displaying the static advertisement on one of an online website and an inbuilt application.

9. The computer program product as claimed in claim 7, wherein the acceleration data is rendered by an accelerometer.

10. The computer program product as claimed in claim 7, wherein the multi-directional data is rendered by a gyroscope.

11. The computer program product as claimed in claim 7 and further comprising
activating the interactive advertisement based on user control of the electronic device.

12. The computer program product as claimed in claim 7 and further comprising
customizing the interactive advertisement by the user.

13. A system for providing online advertisements based on user driven device motion inputs, the system comprising:
an electronic device;
a communication interface in electronic communication with the electronic device;
a memory that stores instructions; and
a processor responsive to the instructions to
receive one or more device motion inputs for a static advertisement from a user of an electronic device;
fetch data based on the one or more device motion inputs, wherein the data comprises at least one of acceleration data and multi-directional data;
correlate the data to one or more objects associated with the static advertisement;
create an interactive advertisement based on correlation of the data to the one or more objects; and
display the interactive advertisement to the user.

14. The system as claimed in claim 13 and further comprising
an electronic storage device that stores the one or more device motion inputs, the data, the static advertisement, and the interactive advertisement.

15. The system as claimed in claim 13 and further comprising
an accelerometer that renders the acceleration data.

16. The system as claimed in claim 13 and further comprising
a gyroscope that renders the multi-directional data.
